(19) United States
(12) Patent Application Publication
(10) Pub. No.: US 2025/0282341 A1
(43) Pub. Date: Sep. 11, 2025

(54) HYBRID VEHICLE, ENGINE STARTING CONTROL METHOD THEREOF, MEDIUM, AND CONTROLLER

(71) Applicant: BYD COMPANY LIMITED, SHENZHEN (CN)

(72) Inventors: Mingjie SHI, Shenzhen (CN); Wei JIANG, Shenzhen (CN); Guoxiang LU, Shenzhen (CN)

(21) Appl. No.: 19/215,113

(22) Filed: May 21, 2025

Related U.S. Application Data
(63) Continuation of application No. PCT/CN2023/115069, filed on Aug. 25, 2023.

(30) Foreign Application Priority Data
Nov. 28, 2022 (CN) 202211504126.3

(51) Int. Cl. B60W 20/10; B60W 10/06; B60W 10/30; B60W 40/12; F02N 11/08

(52) U.S. Cl. CPC B60W 20/10; B60W 10/06; B60W 10/30; B60W 40/12; F02N 11/08; B60W 2510/0638; B60W 2510/0657; B60W 2510/0676; B60W 2710/06; B60W 2710/0644

(57) ABSTRACT

A method for controlling engine start of a hybrid electric vehicle, includes: determining whether an engine start condition is satisfied; in response to that the engine start condition is satisfied, obtaining an engine oil temperature and an engine cooling liquid temperature; searching a correspondence according to the engine oil temperature and the cooling liquid temperature, to obtain a work loss torque of an engine, wherein the correspondence comprises engine oil temperatures, cooling liquid temperatures, and loss torques; and controlling an integrated starter generator (ISG) motor of the hybrid electric vehicle according to the work loss torque, to start the engine.

### CROSS-REFERENCE TO RELATED APPLICATIONS

This application is a Continuation application of International Patent Application No. PCT/CN2023/115069, filed on Aug. 25, 2023, which is based on and claims priority to and benefits of Chinese Patent Application No. 202211504126.3, filed on Nov. 28, 2022. The entire content of all of the above-referenced applications is incorporated herein by reference.

### FIELD

The present disclosure relates to the field of hybrid electric vehicle technologies, and in particular, to a hybrid electric vehicle, and a control method for engine startup, a non-transitory computer-readable storage medium, and a controller thereof.

### BACKGROUND

In a hybrid electric vehicle, when an engine participates in power generation, operating conditions such as engine start, power generation, and shutdown are involved. The engine and an integrated starter generator motor (ISG motor) need to cooperate in the operating conditions. In a cooperation process, torque control is involved. In addition, in an actual operating condition, the engine has a torque loss. In related arts, a loss torque of a used engine may be greatly different from an actual loss torque, causing inaccuracy in engine start control, and affecting working smoothness of the ISG motor.

### SUMMARY

The present disclosure provides a hybrid electric vehicle, and a control method for engine start, a non-transitory computer-readable storage medium, and a controller thereof, so as to improve accuracy of engine start control and ensure working smoothness of an ISG motor.

According to a first aspect, the present disclosure provides a control method for engine start of a hybrid electric vehicle. The method includes: determining whether an engine start condition is satisfied; in response to that the engine start condition is satisfied, obtaining an engine oil temperature and an engine cooling liquid temperature; searching correspondence according to the engine oil temperature and the cooling liquid temperature, to obtain a work loss torque of an engine, where the correspondence comprises engine oil temperatures, cooling liquid temperatures, and loss torques; and controlling an ISG motor of the hybrid electric vehicle according to the work loss torque, to start the engine.

According to a second aspect, the present disclosure provides a non-transitory computer-readable storage medium. The non-transitory computer-readable storage medium stores a computer program. When the computer program is executed by a processor, the foregoing control method for engine start of a hybrid electric vehicle is implemented.

According to a third aspect, the present disclosure provides a controller, including a memory, a processor, and a computer program stored in the memory. When the computer program is executed by the processor, the foregoing control method for engine start of a hybrid electric vehicle is implemented.

According to a fourth aspect, the present disclosure provides a hybrid electric vehicle, including: an engine, an ISG motor, and the foregoing controller.

According to the hybrid electric vehicle, and the control method for engine start, the non-transitory computer-readable storage medium, and the controller thereof in the embodiments of the present disclosure, during startup and control of an engine, the loss torque of the engine is obtained by searching a table/correspondence according to the engine cooling liquid temperature and the engine oil temperature, and a working torque (that is, the target torque) of the ISG motor is back-calculated by using a torque balance formula, to perform engine start control, so that the engine loss torque used in an engine start control process is more accurate, the torque control of the ISG motor is more accurate, the ISG motor and the engine cooperatively work better, and performance in speed variability of the engine is improved.

The additional aspects and advantages of the present disclosure will be provided in the following description, some of which will become apparent from the following description or may be learned from practices of the present disclosure.

### BRIEF DESCRIPTION OF THE DISCLOSURE

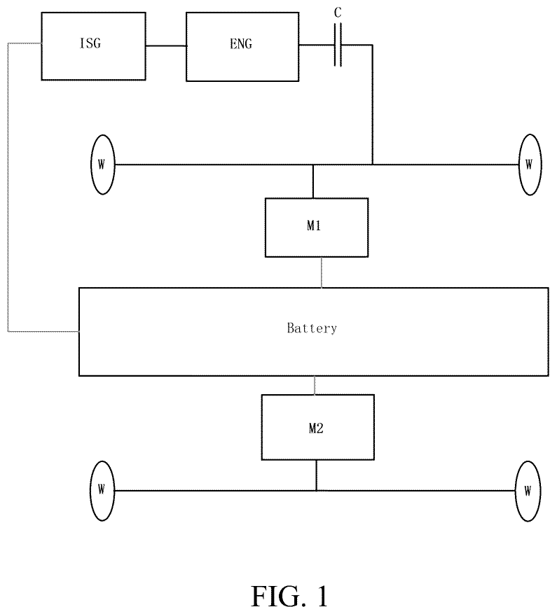

FIG. 1 is a schematic diagram of a power frame of a hybrid electric vehicle according to an embodiment of the present disclosure;

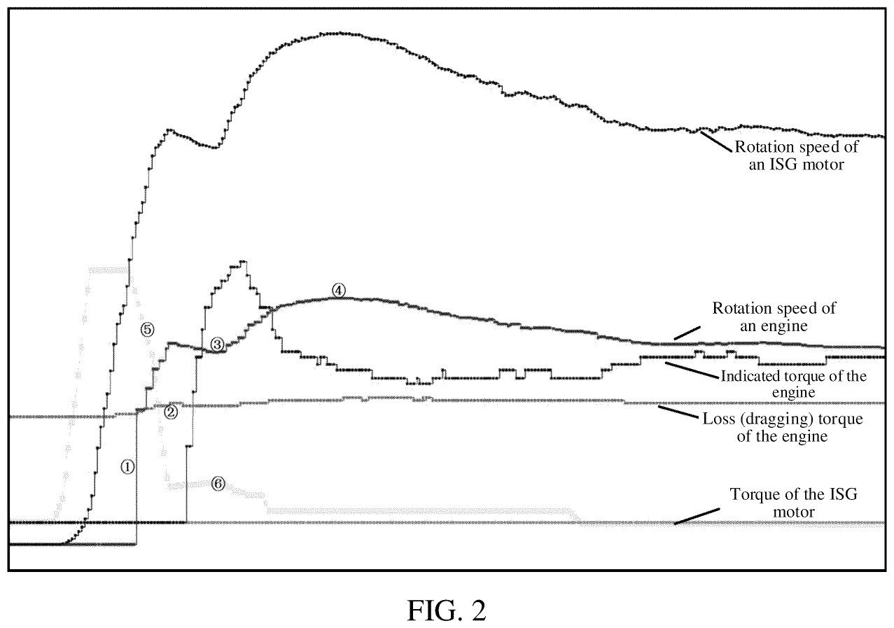

FIG. 2 is a schematic diagram of performance in control of engine start of a hybrid electric vehicle in the related arts;

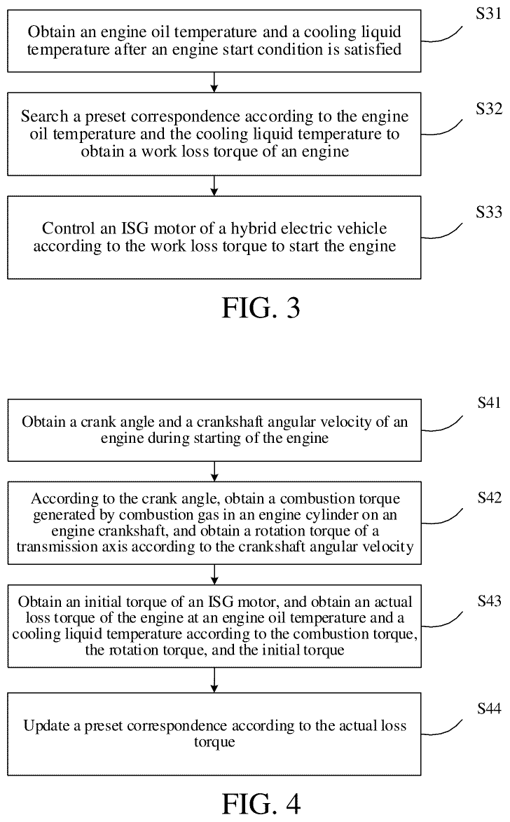

FIG. 3 is a flowchart of a control method for engine start of a hybrid electric vehicle according to an embodiment of the present disclosure;

FIG. 4 is a flowchart of a control method for engine start of a hybrid electric vehicle according to an embodiment of the present disclosure;

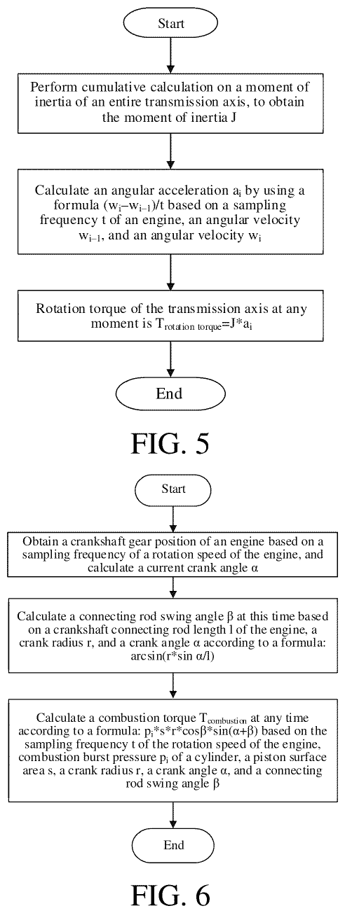

FIG. 5 is a calculation flowchart of a combustion torque according to an embodiment of the present disclosure;

FIG. 6 is a calculation flowchart of a rotation torque according to an embodiment of the present disclosure;

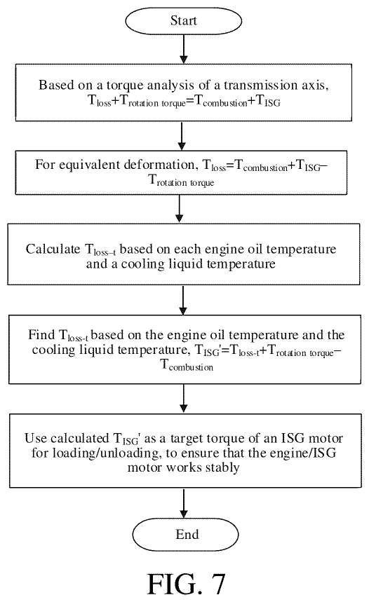

FIG. 7 is a correction flowchart of a loss torque according to an embodiment of the present disclosure;

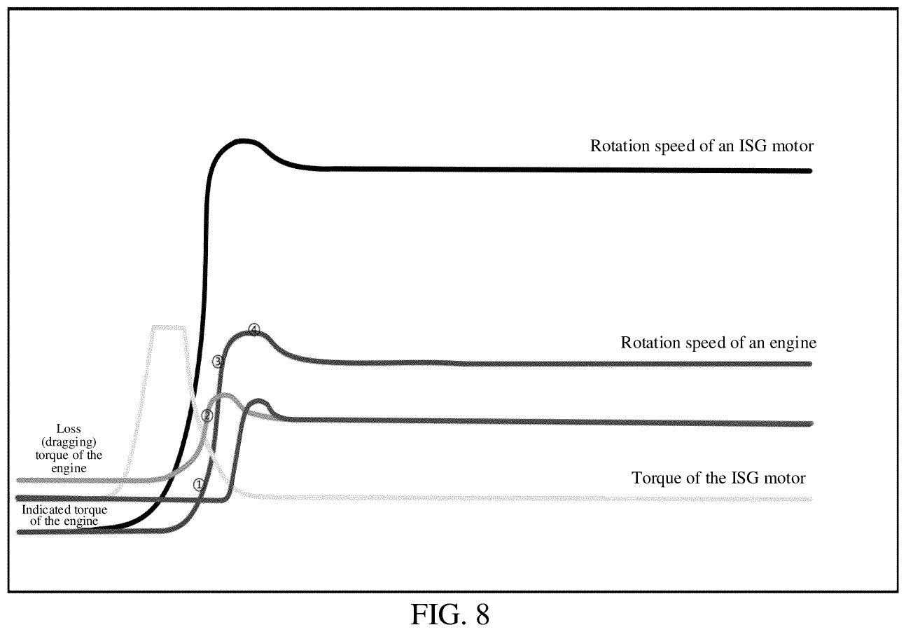

FIG. 8 is a schematic diagram of performance in control of engine start of a hybrid electric vehicle according to the present disclosure;

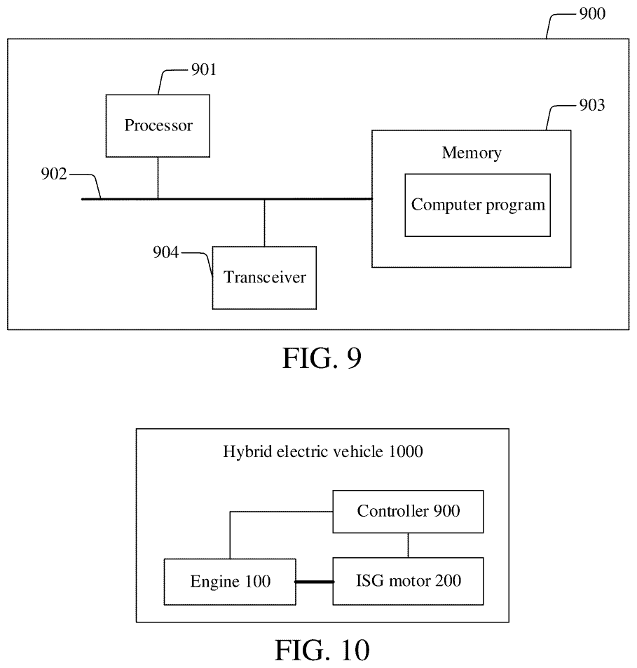

FIG. 9 is a structural block diagram of a controller according to an embodiment of the present disclosure; and

FIG. 10 is a structural block diagram of a hybrid electric vehicle according to an embodiment of the present disclosure.

### DETAILED DESCRIPTION

The embodiments of the present disclosure are described below in detail. Examples of the embodiments are shown in the accompanying drawings, and same or similar reference signs in all the accompanying drawings indicate same or similar components or components having same or similar functions. The embodiments described below with reference to the accompanying drawings are examples, and are merely to explain the present disclosure and cannot be construed as a limitation to the present disclosure.

In the present disclosure, a power architecture of a hybrid electric vehicle is shown in FIG. 1, and includes an integrated starter generator motor (e.g., an ISG motor), an engine (ENG), a clutch (C), a power battery (Battery), and drive motors (M1 and M2). A connection to the power battery is a high-voltage cable connection, other connections are mechanical connections, and W is a wheel of the hybrid electric vehicle. When the engine needs to be started and run, the ISG motor drags the engine to rotate. In this case, the ISG motor is a power source, and the engine is a load. When the engine needs to supplement the power battery with the electric energy, the running engine drives the ISG motor to rotate, and the ISG motor generates electric energy to supplement the power battery. In this case, the engine is a power source, and the ISG motor is a load. When the engine needs to directly participate in driving, the clutches are combined, and the engine directly transmits power to wheel ends.

In the related arts, regardless of an ambient temperature, when the ISG motor drives and starts the engine, a same loss torque is used. The loss torque of engine is inaccurate. Moreover, the ISG motor loads and unloads the torque with a fixed slope. Unstableness exists in a rotation speed transition during startup, causing jitter and rush, and poor performance of startup. It can be learned from an analysis of marked points in FIG. 2 that, a starting process of the related arts has at least the following 6 problems.

1. A dragging torque of the ISG motor is excessively large, a synchronization time of the rotation speed of the engine and of the ISG motor is relatively long, and a workload of a torsional shock absorber is large, which may cause a problem such as an abnormal noise during startup.

2. A loss torque of the engine is inaccurate, and torque control precision of the engine is not high.

3. The rotation speed of the engine has a drop pit, and fluctuation of the rotation speed causes jitter.

4. An upstroke speed of the engine is excessively high, and is usually greater than an idle speed by about 300 rpm.

5. An unloading torque slope of the ISG motor is fixed, which is usually a fixed value, and cannot adapt to various ambient temperature.

6. A torque of the ISG motor is not completely unloaded, and force bearing on a transmission axis is imbalanced, causing a secondary upstroke of the rotation speed.

In view of this, the present disclosure provides a hybrid electric vehicle, and a control method for engine start, a non-transitory computer-readable storage medium, and a controller thereof. In different ambient temperatures, different loss torques are used to control the ISG motor to drag and start the engine, to improve control accuracy of the engine start and ensure smoothness of operation of the ISG motor. The following describes the hybrid electric vehicle, and the control method for engine start, the non-transitory computer-readable storage medium, and the controller thereof in the embodiments of the present disclosure with reference to the accompanying drawings.

FIG. 3 is a flowchart of a control method for engine start of a hybrid electric vehicle according to an embodiment of the present disclosure. As shown in FIG. 3, the control method for engine start includes:

S31: An engine oil temperature and an engine cooling liquid temperature are obtained after an engine start condition is satisfied.

The engine start condition may be that the hybrid electric vehicle starts a Hybrid Electric Vehicle (HEV) mode, or may be that the hybrid electric vehicle needs to perform charging.

In some examples, an HEV switching button is provided in the hybrid electric vehicle. When a user presses the button, a whole vehicle controller of the hybrid electric vehicle obtains a mode-switching instruction of the hybrid electric vehicle. In this case, it may be determined that the hybrid electric vehicle currently meets an engine start condition.

In some examples, when a current remaining power amount of a power battery in the hybrid electric vehicle is less than a first power amount threshold, it is determined that the engine start condition is currently satisfied. The first power amount threshold may be preset, for example, may be set to 10%.

In still some examples, if the hybrid electric vehicle is in a stopping state, when it is detected that a depth of a gas pedal of the hybrid electric vehicle is greater than an opening degree threshold, and a remaining power amount of the power battery is less than a second power amount threshold and greater than the first power amount threshold, it is determined that the engine start condition is currently met.

S32: A preset correspondence is searched according to the engine oil temperature and the cooling liquid temperature to obtain a work loss torque of the engine.

In an embodiment, after the engine start condition is satisfied, the ISG motor and the engine need to cooperate to start the engine. To ensure accuracy of loss torques (including a pumping loss, a ventilation loss, an attachment friction loss, and the like) of the engine during engine start control, in the present disclosure, it is considered that the loss torques of the engine are different due to different viscosities of the engine oil and different friction of the engine at different engine oil temperatures and different cooling liquid temperatures. Correspondences (that is, the foregoing preset correspondences which may be stored in a table form) between the engine oil temperature, the cooling liquid temperature, and the loss torques of the engine are established, so that when the engine start condition is satisfied, the engine oil temperature and the engine cooling liquid temperature are first obtained. Further, the preset correspondence is searched to obtain a corresponding loss torque (that is, the foregoing work loss torque of the engine). The engine oil temperature and the cooling liquid temperature may be detected by setting corresponding temperature sensors.

S33: The ISG motor of the hybrid electric vehicle is controlled according to the work loss torque to start the engine.

In an embodiment, after the work loss torque of the engine is obtained, the target torque of the ISG motor may be obtained based on the work loss torques (for example, a correspondence between the loss torque and the target torque may be established, and then the target torque of the ISG motor is obtained by searching the correspondence based on the work loss torque), and then loading control and unloading control may be performed on the ISG motor according to the target torque. Loading control may be controlling the ISG motor to load a torque to the target torque, and dragging the engine to rotate at the target torque. The unloading control may be controlling the ISG motor to unload a torque when the rotation speed of the engine reaches a rotation speed threshold N1. It should be noted that, while the ISG motor is controlled to unload the torque, the engine is controlled to be ignited and injected with fuel. When the rotation speed of the engine reaches a rotation speed threshold N2, an Engine Management System (EMS) determines that the engine is started. Then, the engine transitions to control of a Vehicle Control Unit (VCU) target torque, and responds to the VCU target torque.

According to the control method for engine start of a hybrid electric vehicle in this embodiment of the present disclosure, when the engine start condition is satisfied, the engine oil temperature and the engine cooling liquid temperature are first obtained, the preset correspondence is further searched to obtain the work loss torque of the engine, and the ISG motor is controlled based on the work loss torque to start the engine, so that accuracy of engine start control can be improved, and smoothness of work of the ISG motor can be ensured.

In some embodiments of the present disclosure, as shown in FIG. 4, the control method for engine start further includes:

S41: A crank angle and a crankshaft angular velocity of an engine are obtained during starting of the engine.

In an embodiment, as shown in FIG. 5, a sampling frequency the same as a sampling frequency of a rotation speed of the engine may be used. In an engine starting process, a crankshaft position gear position at this moment is obtained by using a crankshaft position sensor, and a crank rotation angle α of the engine may be obtained according to the crankshaft position gear position. The crank rotation angle α is a crank rotation angle corresponding to an engine cylinder that is performing expansion work, ranges from 0° to 180°, and is represented as a crankshaft rotation angle of an expansion work stroke. In addition, as shown in FIG. 6, a sampling frequency the same as a sampling frequency of a rotation speed of an engine may be used, and a crankshaft angular velocity may be obtained by using an angular velocity sensor.

S42: According to the crank angle, a combustion torque generated by combustion gas in an engine cylinder on an engine crankshaft is obtained, and a rotation torque of a transmission axis is obtained according to the crankshaft angular velocity.

In some examples, the combustion torque is obtained by using the following formula:

$${T}_{combustion} = {p}_{i} * s * cos β * r * sin ( α + β ) ,$$

where T_{combustion} is the combustion torque, β=arcsin(r*sinα/l) and is a crankshaft connecting rod swing angle, l is a crankshaft connecting rod length, r is a crank radius, s is a surface area of a head of a piston in a cylinder, a is a crank rotation angle, and pᵢ is combustion burst pressure in the cylinder.

In an embodiment, referring to FIG. 5, for the engine of the hybrid electric vehicle, the crankshaft connecting rod length l, the crank radius r, and the surface area s of the head of the piston are fixed values, and a correspondence between the crankshaft connecting rod swing angle β and the crank rotation angle α satisfies β=arcsin(r*sinα/l), that is, the crankshaft connecting rod swing angle β and the crank rotation angle α are in a one-to-one correspondence. In a case in which the crankshaft connecting rod length l, the crank radius r, the surface area s of the head of the piston, the connecting rod swing angle β, the crank rotation angle α, and the combustion burst pressure pᵢ in the cylinder are all known, it can be obtained by analyzing the force bearing on the crankshaft of the piston that high-temperature and high-pressure combustion gas in the cylinder generates a combustion torque to the crankshaft, and T_{combustion}=pᵢ*s*cos β*r*sin(α+β).

In some examples, the rotation torque is obtained by using the following formula:

T_{torque}=J*aᵢ,
where T_{torque} is the rotation torque, J is the moment of inertia of the transmission axis, aᵢ=(wᵢ−wᵢ₋₁)/t and is a crank angular acceleration at an i^{th} moment, wᵢ is a crankshaft angular velocity at the i^{th} moment, and t is a time difference between the i^{th} moment and an (i−1)^{th} moment.

In an embodiment, when the engine has a non-constant rotation speed, a rotation torque may exist on the engine and an entire transmission axis due to a rotation acceleration. Referring to FIG. 6, the moments of inertia of the engine crankshaft, a flywheel, a torsional shock absorber and a rotating component connected to the ISG motor may be obtained through integration and accumulation. It should be noted that for a determined combination of the ISG motor and the engine, the moment of inertia J is a fixed value, may be pre-stored, and is directly read and used when needed.

After obtaining a crankshaft angular speed wᵢ at a current sampling moment and a crankshaft angular speed wᵢ₋₁ at a previous sampling moment, an angular acceleration aᵢ at a current moment may be calculated according to a formula (wᵢ−wᵢ₋₁)/t, and then a rotation torque T_{torque} of a transmission axis at a moment i is obtained according to a formula J*aᵢ.

S43: An initial torque of the ISG motor is obtained, and an actual loss torque of the engine at an engine oil temperature and a cooling liquid temperature is obtained according to the combustion torque, the rotation torque, and the initial torque.

In some examples, the obtaining an actual loss torque of the engine at an engine oil temperature and a cooling liquid temperature according to the combustion torque, the rotation torque, and the initial torque may include: calculating a difference between the combustion torque and the rotation torque, calculating a sum of the difference and the initial torque, and using the sum as the actual loss torque.

In an embodiment, as shown in FIG. 7, as can be known from a torque analysis performed on a transmission axis, at any time point, there is force balance T_{combustion}+T_{ISG}=Tₗₒₛₛ+T_{rotation torque}. T_{ISG} is a positive torque when the engine is started, and is a negative torque when the engine participates in power generation; when the engine rotates at a constant speed, T_{torque} is 0, and T_{combustion}+T_{ISG}=Tₗₒₛₛ. When the engine rotates at a non-constant speed, T_{torque} is not 0, and T_{combustion}+T_{ISG}=Tₗₒₛₛ+T_{rotation torque}.

Referring to FIG. 7, Tₗₒₛₛ=T_{combustion}+T_{ISG}−T_{rotation torque} may be obtained by deforming the equation T_{combustion}+T_{ISG}=Tₗₒₛₛ+T_{rotation torque}. When T_{combustion}, T_{rotation torque} and T_{ISG} are all known, the actual loss torque Tₗₒₛₛ of the engine may be calculated according to the formula Tₗₒₛₛ=T_{combustion}+T_{ISG}−T_{rotation torque}.

It should be noted that, the initial torque of the ISG motor used for calculating the actual loss torque is a constant value, may be a target torque of the ISG motor that is used when the engine is started for the first time after delivery of the hybrid electric vehicle, and is a value set by delivery. In a process of controlling engine start of the hybrid electric vehicle, an actual loss torque may be continuously calculated according to the combustion torque and the rotation torque, to obtain a stable difference between the combustion torque and the rotation torque, so as to obtain stable Tₗₒₛₛ according to the formula Tₗₒₛₛ=T_{combustion}+T_{ISG}−T_{rotation torque}.

S44: The preset correspondence is updated according to the actual loss torque.

In an embodiment, during actual engineering application, the loss torque of the engine is obtained by means of interpolation on a preset table stored in an EMS chip, and a loss torque table is usually measured on an engine rig by using a vanishing cylinder method, a fuel consumption line method, or a drag inversion method, and most of gas engines are measured by using the drag inversion method. Because in the drag inversion method, the loss torque of the engine is usually obtained by measurement at an engine cooling liquid temperature of 85° C. and above and an engine oil temperature of 85° C. and above, the loss torque of the engine measured in the drag inversion method does not consider a rotation torque of a transmission axis, and also does not consider a difference in loss torques of the engine at different engine cooling liquid temperatures and engine oil temperatures. In this way, in an actual service condition of a whole vehicle service condition, a large difference exists between the loss torque of the engine and the actual loss torque obtained through table lookup.

An actual loss torque value of the engine at any time when the entire vehicle is actually used may be obtained from the foregoing formula Tₗₒₛₛ=T_{combustion}+T_{ISG}−T_{rotation torque}. In addition, it is considered that at different engine oil temperatures and different cooling liquid temperatures of the engine, the viscosity of the engine oil is different, the friction of the engine is also different, and the loss torque of the engine is also different. Therefore, it is very necessary to calculate the loss torque Tₗₒₛₛ₋ₜ of the engine for each engine oil temperature and each engine cooling liquid temperature.

Therefore, referring to FIG. 7, in the present disclosure, during each engine start control, the engine oil temperature and the engine cooling liquid temperature are recorded, a motivation loss torque Tₗₒₛₛ₋ₜ is calculated by using a formula Tₗₒₛₛ=T_{combustion}+T_{ISG}−T_{rotation torque}, Tₗₒₛₛ₋ₜ is used as an environment-based adaptive self-learning value of a loss torque of the engine measured by using a drag inversion method, and a current preset correspondence between the engine oil temperature, the engine cooling liquid temperature, and the loss torque is updated. In subsequent actual use of the entire vehicle, if the engine is at an engine oil temperature and an engine cooling liquid temperature, the EMS obtains corresponding Tₗₒₛₛ₋ₜ by means of table lookup, and sends corresponding Tₗₒₛₛ₋ₜ as the loss torque of the engine to a bus of an automobile to interact with other controllers. The updating may be: if the currently recorded engine oil temperature and engine cooling liquid temperature do not exist in the current preset correspondence, directly adding the engine oil temperature, the engine cooling liquid temperature, and the corresponding actual loss torque to the current preset correspondence; or if the currently recorded engine oil temperature and engine cooling liquid temperature exist in the current preset correspondence, replacing the engine oil temperature, the engine cooling liquid temperature, and the corresponding actual loss torque in the current preset correspondence with the existing engine oil temperature, engine cooling liquid temperature, and corresponding actual loss torque. In this way, accuracy of the loss torque of the engine used in the hybrid electric vehicle can be ensured.

In some embodiments, the controlling an ISG motor of the hybrid electric vehicle according to the work loss torque may include: obtaining a target torque of the ISG motor according to the work loss torque, the rotation torque, and the combustion torque; and performing loading control and unloading control on the ISG motor according to the target torque.

In an embodiment, after the loss torque Tₗₒₛₛ₋ₜ of the engine is sent to the bus of the automobile, the ISG motor may determine the target torque of the ISG motor according to a formula T_{ISG}′=Tₗₒₛₛ₋ₜ+T_{rotation torque}−T_{combustion}, to perform loading control and unloading control of the ISG motor.

In some embodiments, the control method for engine start further includes: determining whether the engine is in a constant-speed rotation process according to the crankshaft angular velocity; and if the engine is in the constant-speed rotation process, adjusting fuel injection, ignition, and air intake of the engine, so that the ISG motor works smoothly; or if the engine is in a non-constant-speed rotation process, determining a loading slope and an unloading slope of the ISG motor according to a change of the rotation torque, performing loading control on the ISG motor according to the loading slope, and performing unloading control the ISG motor according to the unloading slope.

In an embodiment, in the constant-speed rotation process of the engine, T_{rotation torque} is 0. In this case, a steady-state operation may be further implemented by adjusting fuel injection, ignition, and air intake of the engine, so that the ISG motor works smoothly, and a load impact caused by fluctuation of a voltage and a current is reduced. In the non-constant-speed rotation process of the engine, T_{rotation torque} is not 0. In this case, the loading slope and the unloading slope of the ISG motor may be determined according to a dynamic change of the rotation torque of the transmission axis, so that the ISG motor and the engine work together better, thereby improving quality in a speed varying process of the engine. The determining the loading slope and the unloading slope of the ISG motor according to a dynamic change of the rotation torque of the transmission axis may be: in a loading process, when the rotation torque is 0, the loading slope is a constant value, and when the rotation torque is greater than 0, the loading slope decreases. In an unloading process, when the rotation torque is 0, the unloading slope is a constant value, and when the rotation torque is greater than 0, the unloading slope increases.

As shown in FIG. 8, after the unloading torque of the ISG motor is adjusted by using the method of the present disclosure, a rotation speed of the engine at a location \textcircled{1} increases stably, the loss torque of the engine at a location \textcircled{2} is accurate, the rotation speed of the engine at a location \textcircled{3} has no drop pit, and an upstroke speed of the engine at a location \textcircled{4} can be controlled to be within 150 rpm. The ISG motor and the engine work together excellently, and startup quality is improved.

Based on the foregoing control method for engine start of a hybrid electric vehicle, the present disclosure further provides a non-transitory computer-readable storage medium.

In this embodiment of this application, a computer program is stored in a non-transitory computer-readable storage medium. When the computer program is executed by a processor, the control method for engine start of a hybrid electric vehicle is implemented.

The present disclosure further provides a controller.

FIG. 9 is a structural block diagram of a controller according to an embodiment of the present disclosure.

As shown in FIG. 9, the controller 900 includes a processor 901 and a memory 903. The processor 901 and the memory 903 are connected, for example, via a bus 902. In an embodiment, the controller 900 may further include a transceiver 904. It should be noted that, in actual application, the transceiver 904 is not limited to one, and a structure of the controller 900 does not constitute a limitation to this embodiment of the present disclosure.

The processor 901 may be a Central Processing Unit (CPU), or may be another general-purpose processor, a Digital Signal Processor (DSP), an Application Specific Integrated Circuit (ASIC), a Field Programmable Gate Array (FPGA) or another programmable logic device, a transistor logic device, a hardware component, or any combination thereof. It may implement or execute various examples of logical blocks, modules, and circuits described in combination with the present disclosure. In an embodiment, the processor 901 may be a combination of processors that implements a computing function, for example, a combination of one or more microprocessors, or a combination of a DSP and a microprocessor.

The bus 902 may include a channel, to transmit information between the foregoing components. The bus 902 may be a Peripheral Component Interconnect (PCI) bus, an Extended Industry Standard Architecture (EISA) bus, or the like. The bus 902 may be classified into an address bus, a data bus, a control bus, and the like. For ease of representation, only one bold line is used to represent the bus in FIG. 5, but this does not mean that there is only one bus or only one type of bus.

The memory 903 is configured to store a computer program corresponding to the control method for engine startup of a hybrid electric vehicle in the foregoing embodiments of the present disclosure. The computer program is controlled and executed by the processor 901. The processor 901 is configured to execute computer programs stored in a memory 903, to implement content shown in the foregoing method embodiments.

It should be noted that, the controller 900 shown in FIG. 9 is merely an example, and should not constitute any limitation on functions and use ranges of the embodiments of the present disclosure.

The present disclosure further provides a hybrid electric vehicle.

FIG. 10 is a structural block diagram of a hybrid electric vehicle according to the present disclosure.

As shown in FIG. 10, the hybrid electric vehicle 1000 includes an engine 100, an ISG motor 200, and the controller 900 in the foregoing embodiment.

In conclusion, according to the hybrid electric vehicle, and the control method for engine startup, the non-transitory computer-readable storage medium, and the controller thereof in the embodiments of the present disclosure, an actual loss torque in a rotation process of the engine is calculated by using the initial torque of the ISG motor, the combustion torque of the engine, and the rotation torque of the transmission axis. Meanwhile, the engine cooling liquid temperature and the engine oil temperature in the operation condition are obtained, and the temperature and an actual loss torque corresponding to the temperature are used as environmental-based adaptive self-learning values, to update the preset correspondence stored in the EMS. Further, in subsequent (next or several) engine start control, the loss torque of the engine is obtained by looking up a table according to the engine cooling liquid temperature and the engine oil temperature, and the working torque (that is, the target torque) of the ISG motor is back-calculated by using a torque balance formula, so as to control the engine start. Therefore, the loss torque of the engine used in an engine start control process is more accurate, so that ISG motor torque control is more accurate, the ISG motor and the engine work together excellently, and the speed varying quality of the engine is improved.

It should be noted that, the logic and/or steps shown in the flowcharts or described in any other manner herein, for example, a sequenced list that may be considered as executable instructions used for implementing logical functions, may be implemented in any computer-readable medium to be used by an instruction execution system, apparatus, or device (for example, a computer-based system, a system including a processor, or another system that can obtain an instruction from the instruction execution system, apparatus, or device and execute the instruction) or to be used by combining such instruction execution systems, apparatuses, or devices. In the specification of this application, the “computer-readable medium” may be any apparatus that can include, store, communicate, propagate, or transmit programs to be used by the instruction execution system, apparatus or device or to be used in combination with the instruction execution system, apparatus or device. More examples (a non-exhaustive list) of the non-transitory computer-readable medium include the following: an electrical connection part (electronic device) having one or more wires, a portable computer diskette (magnetic apparatus), a random access memory (RAM), a read-only memory (ROM), an erasable programmable read-only memory (EPROM or flash memory), an optical fiber apparatus, and a portable compact disk read-only memory (CDROM). In addition, the non-transitory computer-readable medium may even be paper or another suitable medium on which the program can be printed, because the program can be obtained in an electronic manner, for example, by performing optical scanning on the paper or other medium, and then performing editing and interpretation, or performing processing in another suitable manner when necessary, and then the program is stored in a computer memory.

It should be understood that, parts of the present disclosure can be implemented by using hardware, software, firmware, or a combination thereof. In the foregoing implementations, a number of steps or methods may be implemented by using software or firmware that are stored in a memory and are executed by a proper instruction execution system. For example, if hardware is used for implementation, same as in another implementation, implementation may be performed by any one of the following technologies well known in the art or a combination thereof: a discrete logic circuit of a logic gate circuit for realizing a logic function for a data signal, an application specific integrated circuit having a suitable combined logic gate circuit, a programmable gate array (PGA), and a field programmable gate array (FPGA).

In the description of this specification, the description of the reference terms “an embodiment”, “some embodiments”, “an example”, “a specific example”, “some examples,” and the like means that features, structures, materials or characteristics described in combination with the embodiment(s) or example(s) are included in at least one embodiment or example of the present disclosure. In this specification, descriptions of the foregoing terms do not necessarily refer to the same embodiment or example. In addition, the described features, structures, materials, or characteristics may be combined in a proper manner in any one or more of the embodiments or examples.

In the description of the present disclosure, it should be understood that orientation or position relationships indicated by the terms such as “center”, “longitudinal”, “transverse”, “length”, “width”, “thickness”, “on”, “below”, “front”, “back”, “left”, “right”, “vertical”, “horizontal”, “top”, “bottom”, “inside”, “outside”, “clockwise”, “anticlockwise”, “axial”, “radial”, and “circumferential” are based on orientation or position relationships shown in the accompanying drawings, and are used only for ease and brevity of illustration and description, rather than indicating or implying that the mentioned apparatus or component must have a particular orientation or must be constructed and operated in a particular orientation. Therefore, such terms should not be construed as a limit to the present disclosure.

In addition, terms “first” and “second” are used merely for the purpose of description, and shall not be construed as indicating or implying relative importance or implying a quantity of indicated technical features. Therefore, a feature restricted by “first” or “second” may explicitly indicate or implicitly include at least one of such features. In the descriptions of the present disclosure, unless explicitly specified, “multiple” means at least two, for example, two or three.

In the present disclosure, it should be noted that unless otherwise explicitly specified and limited, the terms “mount”, “connect”, “connection”, and “fix” should be understood in a broad sense. For example, a connection may be a fixed connection, a detachable connection, or an integral connection; or the connection may be a mechanical connection or an electrical connection; or the connection may be a direct connection, an indirect connection through an intermediary, or internal communication between two elements or mutual action relationship between two elements, unless otherwise specified explicitly. A person of ordinary skill in related arts can understand meanings of the terms in the present disclosure based on certain situations.

In the present disclosure, unless otherwise explicitly specified or defined, the first feature being located “above” or “below” the second feature may be the first feature being in a direct contact with the second feature, or the first feature being in an indirect contact with the second feature through an intermediary. In addition, that the first feature is “above”, “over”, or “on” the second feature may indicate that the first feature is directly above or obliquely above the second feature, or may merely indicate that the horizontal position of the first feature is higher than that of the second feature. That the first feature is “below”, “under”, and “beneath” the second feature may be that the first feature is right below the second feature or at an inclined bottom of the second feature, or may merely indicate that the horizontal position of the first feature is lower than that of the second feature.

Although the embodiments of the present disclosure have been shown and described above, it can be understood that, the foregoing embodiments are examples and should not be understood as a limitation to the present disclosure. A person of ordinary skill in the art can make changes, modifications, replacements, or variations to the foregoing embodiments within the scope of the present disclosure.

What is claimed is:

1. A method for controlling engine start of a hybrid electric vehicle, comprising:
determining whether an engine start condition is satisfied;
in response to that the engine start condition is satisfied, obtaining an engine oil temperature and an engine cooling liquid temperature;
searching a correspondence according to the engine oil temperature and the cooling liquid temperature, to obtain a work loss torque of an engine, wherein the correspondence comprises engine oil temperatures, cooling liquid temperatures, and loss torques; and
controlling an integrated starter generator (ISG) motor of the hybrid electric vehicle according to the work loss torque, to start the engine.

2. The method according to claim 1, further comprising:
acquiring a crank angle and a crankshaft angular velocity of the engine in a process of starting the engine;
obtaining, according to the crank angle, a combustion torque generated by combustion gas in an engine cylinder on an engine crankshaft, and obtaining a rotational torque of a transmission axis according to the crankshaft angular velocity; and
obtaining an initial torque of the ISG motor, and obtaining an actual loss torque of the engine at the engine oil temperature and the cooling liquid temperature according to the combustion torque, the rotation torque, and the initial torque; and
updating the correspondence according to the actual loss torque.

3. The method according to claim 2, wherein the obtaining the actual loss torque of the engine at the engine oil temperature and the cooling liquid temperature according to the combustion torque, the rotation torque, and the initial torque comprises:
calculating a difference between the combustion torque and the rotation torque, calculating a sum of the difference and the initial torque, and using the sum as the actual loss torque.

4. The method according to claim 2, wherein the combustion torque is obtained by:
$${T}_{combustion} = {p}_{i} * s * cos β * r * sin ( α + β ) ,$$
wherein T_{combustion} is the combustion torque, β=arcsin(r*sinα/l) and is a crankshaft connecting rod swing angle, l is a crankshaft connecting rod length, r is a radius of a crank, s is a surface area of a head of a piston in a cylinder, a is a crank rotation angle, and pᵢ is a combustion burst pressure in the cylinder.

5. The method according to claim 2, wherein the rotation torque is obtained by:
T_{torque}=J*aᵢ,
wherein T_{torque} is the rotation torque, J is a moment of inertia of the transmission axis, aᵢ=(wᵢ−wᵢ₋₁)/t and is a crankshaft angular acceleration at an i^{th} moment, wᵢ is a crankshaft angular velocity at the i^{th} moment, and tis a time difference between the i^{th} moment and an (i−1)^{th} moment.

6. The method according to claim 2, wherein the controlling an ISG motor of the hybrid electric vehicle according to the work loss torque comprises:
obtaining a target torque of the ISG motor according to the work loss torque, the rotation torque, and the combustion torque; and
performing loading control and unloading control on the ISG motor according to the target torque.

7. The method according to claim 6, further comprising:
determining whether the engine is in a constant-speed rotation process according to the crankshaft angular velocity; and
in response to that the engine is in the constant-speed rotation process, adjusting fuel injection, ignition, and air intake of the engine; or in response to that the engine is in a non-constant-speed rotation process, determining a loading slope and an unloading slope of the ISG motor according to a change of the rotation torque, performing loading control on the ISG motor according to the loading slope, and performing unloading control on the ISG motor according to the unloading slope.

8. A non-transitory computer-readable storage medium, storing a computer program, when the computer program is executed by a processor to cause the processor to perform operations comprising:
determining whether an engine start condition is satisfied;
in response to that the engine start condition is satisfied, obtaining an engine oil temperature and an engine cooling liquid temperature;
searching a correspondence according to the engine oil temperature and the cooling liquid temperature, to obtain a work loss torque of an engine, wherein the correspondence comprises engine oil temperatures, cooling liquid temperatures, and loss torques; and
controlling an integrated starter generator (ISG) motor of the hybrid electric vehicle according to the work loss torque, to start the engine.

9. A controller, comprising a memory, a processor, and a computer program stored in the memory, and when the computer program is executed by the processor, the controller is configured to perform operations comprising:
determining whether an engine start condition is satisfied;
in response to that the engine start condition is satisfied, obtaining an engine oil temperature and an engine cooling liquid temperature;
searching a correspondence according to the engine oil temperature and the cooling liquid temperature, to obtain a work loss torque of an engine, wherein the correspondence comprises engine oil temperatures, cooling liquid temperatures, and loss torques; and
controlling an integrated starter generator (ISG) motor of the hybrid electric vehicle according to the work loss torque, to start the engine.

10. The controller according to claim 9, wherein the operations further comprise:
acquiring a crank angle and a crankshaft angular velocity of the engine in a process of starting the engine;
obtaining, according to the crank angle, a combustion torque generated by combustion gas in an engine cylinder on an engine crankshaft, and obtaining a rotational torque of a transmission axis according to the crankshaft angular velocity; and
obtaining an initial torque of the ISG motor, and obtaining an actual loss torque of the engine at the engine oil temperature and the cooling liquid temperature according to the combustion torque, the rotation torque, and the initial torque; and
updating the correspondence according to the actual loss torque.

11. The controller according to claim 10, wherein the obtaining the actual loss torque of the engine at the engine oil temperature and the cooling liquid temperature according to the combustion torque, the rotation torque, and the initial torque comprises:
calculating a difference between the combustion torque and the rotation torque, calculating a sum of the difference and the initial torque, and using the sum as the actual loss torque.

12. The controller according to claim 10, wherein the combustion torque is obtained by:
$${T}_{combustion} = {p}_{i} * s * cos β * r * sin ( α + β ) ,$$
wherein T_{combustion} is the combustion torque, β=arcsin(r*sinα/l) and is a crankshaft connecting rod swing angle, l is a crankshaft connecting rod length, r is a radius of a crank, s is a surface area of a head of a piston in a cylinder, a is a crank rotation angle, and pᵢ is a combustion burst pressure in the cylinder.

13. The controller according to claim 10, wherein the rotation torque is obtained by:
T_{torque}=J*aᵢ,
wherein T_{torque} is the rotation torque, J is a moment of inertia of the transmission axis, aᵢ=(wᵢ−wᵢ₋₁)/t and is a crankshaft angular acceleration at an i^{th} moment, wᵢ is a crankshaft angular velocity at the i^{th} moment, and t is a time difference between the i^{th} moment and an (i−1)^{th} moment.

14. The controller according to claim 10, wherein the controlling an ISG motor of the hybrid electric vehicle according to the work loss torque comprises:
obtaining a target torque of the ISG motor according to the work loss torque, the rotation torque, and the combustion torque; and
performing loading control and unloading control on the ISG motor according to the target torque.

15. The controller according to claim 14, wherein the operations further comprise:
determining whether the engine is in a constant-speed rotation process according to the crankshaft angular velocity; and
in response to that the engine is in the constant-speed rotation process, adjusting fuel injection, ignition, and air intake of the engine; or in response to that the engine is in a non-constant-speed rotation process, determining a loading slope and an unloading slope of the ISG motor according to a change of the rotation torque, performing loading control on the ISG motor according to the loading slope, and performing unloading control on the ISG motor according to the unloading slope.

16. A hybrid electric vehicle, comprising: an engine, an ISG motor, and the controller according to claim 9.
